(19) United States
(12) Patent Application Publication
(10) Pub. No.: US 2026/0099531 A1
(43) Pub. Date: Apr. 9, 2026

(54) Electronic Devices and Corresponding Methods for Notification Precis Presentations

(71) Applicant: Motorola Mobility LLC, Chicago, IL (US)

(72) Inventors: Vijaykumar GN, Bagalore (IN); Vineet Vivekanand Angadi, Dharwad (IN); Ashwin Kumar Manmohan Pathmudi, Pune (IN); Amit Kumar Agrawal, Bangalore (IN)

(21) Appl. No.: 18/911,053

(22) Filed: Oct. 9, 2024

(51) Int. Cl. G06F 16/34; G10L 13/08; G10L 25/78

(52) U.S. Cl. CPC G06F 16/345; G10L 13/08; G10L 25/78

(57) ABSTRACT

An electronic device and corresponding methods manage notifications by creating a precis of a received notification, presenting the precis via a user interface, and detecting user interest through sensors. If user interest exceeds a threshold, the full notification is presented. The system can optionally determine the duration required for the notification presentation and announces the duration. The precis can be generated using artificial intelligence and may be presented only when the device is in a vehicle. The system dynamically adjusts the notification presentation based on user engagement, enhancing safety and user experience by minimizing distractions, particularly while driving.

### BACKGROUND

### Technical Field

This disclosure relates generally to electronic devices, and more particularly to electronics having user interfaces.

### Background Art

Users often face challenges in managing communications received by an electronic device when they are unable to interact with the electronic device directly. Situations such as driving can introduce challenges when it comes to managing audio readouts of received communications. For instance, users often encounter difficulties with lengthy and cumbersome audio readouts, which can be distracting and inappropriate while driving. Current audio readout systems do not allow users to interrupt the message, which can lead to potential safety hazards and inefficiencies. It would be advantageous to have improved methods and electronic devices for managing communications received by an electronic device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates an explanatory electronic device in accordance with one or more embodiments of the disclosure.

FIG. 3 illustrates another explanatory method in accordance with one or more embodiments of the disclosure.

FIG. 4 illustrates yet another explanatory method in accordance with one or more embodiments of the disclosure.

FIG. 5 illustrates one or more method steps in accordance with one or more embodiments of the disclosure.

FIG. 6 illustrates still another explanatory method in accordance with one or more embodiments of the disclosure.

FIG. 7 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to creating, by one or more processors in response to a notification being received by a communication device of the electronic device, a precis of the notification, presenting, by a user interface of the electronic device, the precis of the notification to an environment of the electronic device, detecting, by one or more sensors in response to the presenting, an interest level of an authorized user of the electronic device in the precis of the notification, and where the interest level of the authorized user of the electronic device exceeds a threshold, also presenting the notification in its entirety to the environment of the electronic device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, when one or more processors of an electronic device in response to the communication device receive a notification, determing, from signals received by the one or more sensors, an attentiveness of an authorized user of the electronic device and causing the user interface to present a precis of the notification when the attentiveness of the authorized user is determined to be inattentive, and presenting the notification in its entirety when the attentiveness of the authorized user is determined to be attentive as described herein. The non-processor circuits may include, but are not limited to, a radio receiver, a radio transmitter, signal drivers, clock circuits, power source circuits, and user input devices.

As such, these functions may be interpreted as steps of a method to perform determining, by one or more sensors of the electronic device, that the electronic device is being transported by a vehicle, determining, in response to a communication device receiving a notification, a duration required to aurally present the notification to an environment of the electronic device using a user interface, generating, by one or more processors, an artificial intelligence (AI)-based summary of the notification, aurally presenting, by the user interface, the duration required to aurally present the notification to the environment and the AI-based summary of the notification to the environment of the electronic device, assessing, using the one or more sensors, an interest by an authorized user of the electronic device in the notification while the AI-based summary of the notification is being presented to the environment of the electronic device, and where the one or more processors determine the authorized user is sufficiently interested in the notification, aurally presenting, by the user interface, the notification in its entirety to the environment of the electronic device

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure address the challenge of managing aural presentations of notifications and other electronic communications. Embodiments of the disclosure are especially useful when a person is driving, i.e., when an electronic device is experiencing a driving mode, but can be used in other circumstances as well.

Embodiments of the disclosure contemplate that users often encounter difficulties with lengthy and cumbersome aural representations of notification and communication presentations, which can be distracting and inappropriate while driving. As noted above, prior art systems do not allow users to interrupt such aural presentations. This can lead to potential safety hazards and inefficiencies. The problem becomes more pronounced with the introduction of various readout modes such as Android.sup.TM Auto and Drive mode, where users receive long messages, stories, jokes, and other communications and notifications via short message service (SMS) messages, chats, or emails. Embodiments of the disclosure provide solutions to manage aural presentations, optionally using artificial intelligence, by determining the readout duration and presenting a quick summary or precis of the incoming notification. This approach ensures that users receive concise and relevant information without compromising their attention on the road.

In one or more embodiments, a method in an electronic device comprises creating, by one or more processors in response to a notification being received by a communication device of the electronic device, a precis of the notification. In one or more embodiments, the method comprises presenting, by a user interface of the electronic device, the precis of the notification to an environment of the electronic device.

In one or more embodiments, the method comprises detecting, by one or more sensors in response to the presenting, an interest level of an authorized user of the electronic device in the precis of the notification. In one or more embodiments, where the interest level of the authorized user of the electronic device exceeds a threshold, the method comprises also presenting the notification in its entirety to the environment of the electronic device

By creating a precis of the notification in response to its receipt, the method ensures that users receive a concise summary of the notification, which is particularly useful in situations where the user cannot directly interact with the device, such as while driving. This reduces the cognitive load on the user and minimizes distractions, thereby enhancing safety.

Presenting the precis of the notification via the user interface to the environment of the electronic device allows the user to quickly grasp the essential information without needing to engage with the device physically. This is advantageous in maintaining the user's focus on critical tasks, such as driving, while still keeping them informed.

Detecting the interest level of the authorized user through sensors in response to the precis presentation allows the system to dynamically adjust the level of detail provided. If the user's interest exceeds a threshold, the method then presents the full notification, ensuring that the user receives all necessary information only when they are ready and able to process it. This adaptive approach optimizes the information delivery based on user engagement, improving the overall user experience.

The arrangement of using sensors to detect user interest and adjusting the notification presentation accordingly is novel compared to existing solutions, which typically do not account for user attentiveness. This method provides a more intelligent and user-centric way of managing notifications, particularly in scenarios where user attention is divided, such as driving.

For example, if a user receives a lengthy email while driving, the system will first present a brief summary. If the user shows interest by, for instance, not engaging in other activities or conversations, the system will then read out the entire email. This ensures that the user gets the complete information only when it is safe and convenient, thereby reducing the risk of accidents and improving the efficiency of information consumption.

In one or more embodiments, electronic devices and corresponding methods involve managing (optionally artificial intelligence (AI)-based) aural presentations or “audio readouts” of notifications and communications during a drive mode by determining the user's driving status and enabling a readout mode for incoming notifications. In one or more embodiments, upon detecting an incoming notification, the system assesses the time required to complete the readout based on the length of the associated textual information.

In one or more embodiments, the system then presents an AI-generated quick summary of the notification as an audio readout. Optionally, the system informs the user about the readout duration and allows the user to choose between messages based on their duration.

In one or more embodiments, the system also assesses the user's interest in the message readout. In another embodiment, the user can preconfigure a readout threshold, such as five seconds. For each readout, the device reads approximately five seconds of content or completes the sentence and then asks the user if they are interested in the rest of the audio content or a more detailed description.

Another method for managing single audio readouts involves determining the time duration needed to complete the readouts before notifying the user. If the readout content exceeds a pre-configured threshold, the system presents a partial readout along with the remaining time duration needed to complete the readout. The system then prompts the user after the partial readout, asking if they are interested in listening to the rest of the audio message. If the user responds affirmatively, the system presents the rest of the audio readout. If the user responds negatively, the system aborts the readout.

Advantageously, embodiments of the disclosure dynamically adjust the readout content based on the user's attentiveness and the duration of the readout. Unlike existing solutions that provide lengthy and uninterrupted audio readouts, embodiments of the disclosure introduce a more intelligent and user-centric approach. In one or more embodiments, the system determines the user's driving status and enables a readout mode for incoming notifications. It then assesses the time required to complete the readout and presents an AI-generated quick summary of the notification as an audio readout.

Additionally, embodiments of the disclosure can inform the user about the readout duration and allows the user to choose between messages based on their duration. The system also assesses the user's interest in the message readout and dynamically adjusts the level of detail provided. In another embodiment, the user can preconfigure a readout threshold, such as five seconds, and the device reads approximately five seconds of content or completes the sentence before asking the user if they are interested in the rest of the audio content or a more detailed description.

This approach ensures that users receive concise and relevant information without compromising their attention on the road. The method's ability to dynamically adjust the readout content based on user engagement and readout duration provides a more efficient and safer way to manage notifications during driving mode. This novel combination of AI-based summarization, user attentiveness assessment, and dynamic readout adjustment sets this invention apart from existing solutions.

In one or more embodiments, an electronic device comprises a user interface, one or more sensors, a communication device, and one or more processors operable with the user interface, the one or more sensors, and the communication device. In one or more embodiments, the one or more processors, in response to the communication device receiving a notification, determine, from signals received by the one or more sensors, an attentiveness of an authorized user of the electronic device. In one or more embodiments, the one or more processors cause the user interface to present a precis of the notification when the attentiveness of the authorized user is determined to be inattentive and present the notification in its entirety when the attentiveness of the authorized user is determined to be attentive.

Advantageously, the processors are configured to determine the attentiveness of an authorized user based on signals received from the sensors and to adjust the presentation of notifications accordingly. This arrangement ensures that the user receives a precis of the notification when they are inattentive and the full notification when they are attentive.

This configuration provides a practical solution to the problem of managing notifications in situations where user attention is divided, such as while driving. By dynamically adjusting the level of detail in the notification based on user attentiveness, the system minimizes distractions and enhances safety. For example, if the user is driving and not paying full attention, the device will present a concise summary of the notification, reducing cognitive load and allowing the user to stay focused on driving. Conversely, if the user is attentive, the device will present the full notification, ensuring that important information is not missed.

The integration of sensors to detect user attentiveness and the adaptive presentation of notifications is a novel approach compared to existing solutions, which typically do not account for user engagement levels. This method leverages real-time data from the sensors to make intelligent decisions about how to present notifications, thereby improving the overall user experience and safety. For instance, the sensors could include microphones to detect the absence of speech, indicating attentiveness, or image capture devices to monitor user interactions with vehicle controls, indicating inattentiveness.

In practical applications, this system can be particularly beneficial in automotive environments where user attention is critical. For example, if a driver receives a lengthy email while driving, the system will first present a brief summary. If the driver shows interest by not engaging in other activities or conversations, the system will then read out the entire email. This ensures that the driver gets the complete information only when it is safe and convenient, thereby reducing the risk of accidents and improving the efficiency of information consumption.

Other embodiments of the disclosure manage audio readouts based on user attentiveness. Illustrating by example, in one or more embodiments the system starts with a quick introduction, determines user attentiveness through image analysis, button interactions, volume adjustments, and audio analysis. Based on the user attentiveness score, the system decides whether to continue the readout.

In one or more embodiments, a method comprises determining, by one or more sensors of the electronic device, that the electronic device is being transported by a vehicle. In one or more embodiments, the method comprises determining, in response to a communication device receiving a notification, a duration required to aurally present the notification to an environment of the electronic device using a user interface.

In one or more embodiments, the method comprises generating, by one or more processors, an artificial intelligence (AI)-based summary of the notification and aurally presenting, by the user interface, the duration required to aurally present the notification to the environment and the AI-based summary of the notification to the environment of the electronic device. In one or more embodiments, the method comprises assessing, using the one or more sensors, an interest by an authorized user of the electronic device in the notification while the AI-based summary of the notification is being presented to the environment of the electronic device. In one or more embodiments, where the one or more processors determine the authorized user is sufficiently interested in the notification, the method comprises aurally presenting, by the user interface, the notification in its entirety to the environment of the electronic device.

Advantageously, by determining that the electronic device is being transported by a vehicle, the system can automatically activate a driving mode, ensuring that notifications are managed in a way that minimizes distractions for the user. This is particularly useful for enhancing safety while driving.

Determining the duration required to aurally present the notification allows the system to provide the user with an estimate of how long the notification will take to listen to, which helps the user make an informed decision about whether to listen to the entire notification or not. This feature is beneficial in managing the user's time and attention effectively.

Generating an AI-based summary of the notification ensures that the user receives a concise and relevant summary of the notification, which is easier to comprehend quickly compared to the full notification. This reduces cognitive load and helps maintain the user's focus on driving.

Aurally presenting both the duration required to aurally present the notification and the AI-based summary provides the user with essential information in a format that is easy to consume without taking their eyes off the road. This enhances the overall user experience by making the information accessible and less intrusive.

Assessing the user's interest in the notification while the AI-based summary is being presented allows the system to dynamically adjust the level of detail provided based on real-time user engagement. This ensures that the user receives the full notification only if they are sufficiently interested, thereby optimizing the information delivery process.

By aurally presenting the notification in its entirety only when the user is sufficiently interested, the system prevents unnecessary distractions and interruptions, which is crucial for maintaining safety while driving. This adaptive approach to notification management is more intelligent and user-centric compared to existing solutions. Other advantages will be described below. Still others will be obvious to those of ordinary skill in the art having the benefit of this disclosure.

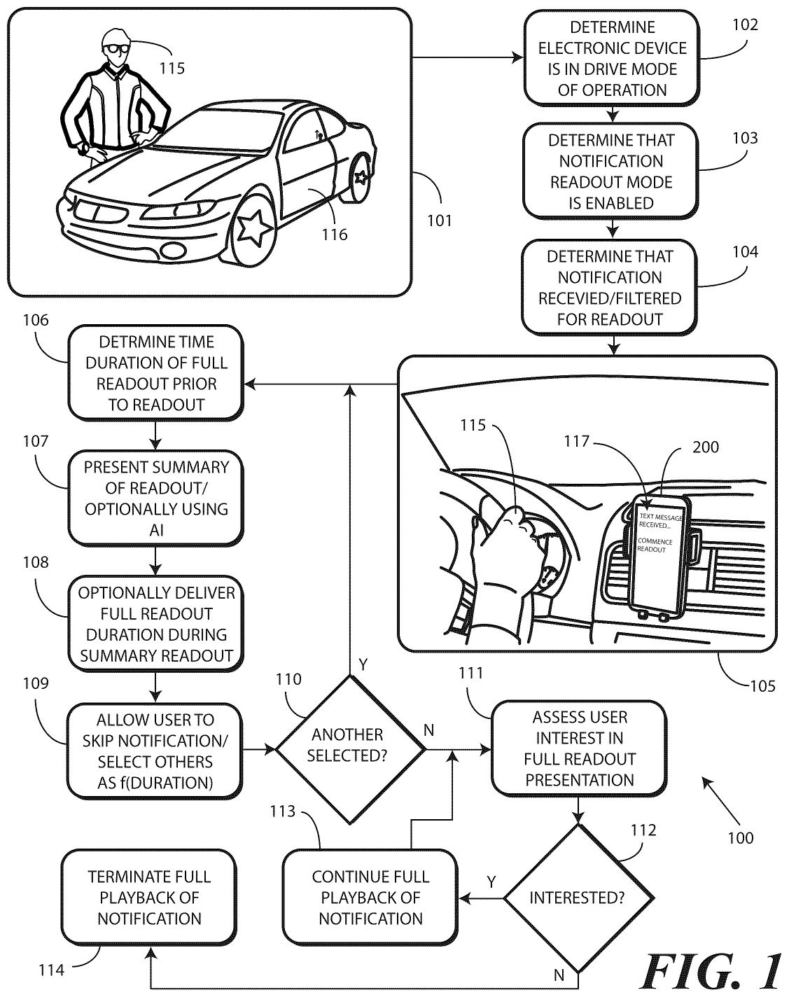

Turning now to FIG. 1, illustrated therein is one explanatory method 100 in accordance with one or more embodiments of the disclosure. In one or more embodiments, the method 100 facilitates the aural presentation of messages and notifications by dynamically adjusting the content based on user attentiveness. In one or more embodiments, a quick introduction is delivered while the system determines user attentiveness through various means such as image analysis, button interactions, volume adjustments, and audio analysis. For instance, if the user increases the volume, the system interprets this as interest, whereas a decrease in volume indicates disinterest. Similarly, if the user starts a side conversation, the system deems the user uninterested. Based on the user attentiveness score, the system decides whether to continue the readout.

In one embodiment, the method 100 includes determining that the user is driving and enabling a readout mode for incoming notifications. Upon detecting an incoming notification, the method 100 assesses the time required to complete the readout based on the length of the associated textual information. The method 100 then presents an AI-generated quick summary of the notification as an audio readout.

Optionally, the method 100 informs the user about the readout duration and allows the user to choose between messages based on their duration. The method 100 also assesses the user's interest in the message readout. If the user shows interest, the method 100 presents the rest of the audio readout. If the user responds negatively, the system aborts the readout.

Another embodiment allows the user to preconfigure a readout threshold, such as five seconds. For each readout, the device reads approximately five seconds of content or completes the sentence and then asks the user if they are interested in the rest of the audio content or a more detailed description. This approach ensures that users receive concise and relevant information without compromising their attention on the road. The method's ability to dynamically adjust the readout content based on user engagement and readout duration provides a more efficient and safer way to manage notifications during driving mode.

Beginning at step 101 of FIG. 1, a user 115, with an electronic device 200 in her pocket, approaches her vehicle 116, ready to embark on a trip to Buster's Chicken Shack. The anticipation is palpable as she thinks about the delicious meal awaiting her. Buster's Chicken Shack is renowned for its world-famous chicken, served in eight different ways, each more mouth-watering than the last. The user 115 has been looking forward to this meal all week, and the thought of savoring the crispy, juicy chicken makes her heart race with excitement.

As she gets into her vehicle 116, she can almost taste the variety of chicken dishes that Buster's Chicken Shack offers. Whether it's the classic fried chicken, the tangy barbecue chicken, the spicy buffalo wings, or the savory chicken tenders, each dish is a culinary delight that has earned Buster's its stellar reputation. The user 115 is particularly fond of the chicken pot pie, with its flaky crust and rich, creamy filling, and the grilled chicken, which is perfectly seasoned and cooked to perfection.

The user excitement is not just about the food; it's also about the experience. Buster's Chicken Shack is a place where she can relax and enjoy a great meal in a friendly, welcoming atmosphere. The restaurant's accolades and rave reviews from food critics and customers alike add to her anticipation. She knows that dining at Buster's is not just about satisfying her hunger; it's about indulging in a culinary experience that leaves a lasting impression.

With her electronic device 200 in her pocket, the user 115 is ready to drive to Buster's Chicken Shack, knowing that the device will manage her notifications efficiently while she focuses on the road. The AI-based notification summarization system will ensure that she doesn't miss any important communications, presenting a concise summary of notifications when she arrives at her destination. This seamless integration of technology into her daily routine enhances her overall experience, making the trip to Buster's Chicken Shack even more enjoyable.

At step 102 of FIG. 1, one or more sensors of the electronic device 200 determine that the electronic device 200 is being transported by the vehicle 116. The sensors can include accelerometers, gyroscopes, GPS modules, and other motion-detecting components. The accelerometers can detect changes in velocity and orientation, indicating that the electronic device 200 is in motion consistent with vehicular travel. Gyroscopes can measure angular velocity, providing data on the device's orientation and movement patterns, which can be cross-referenced with typical vehicle motion profiles.

Additionally, the GPS module can provide real-time location data, allowing the system to determine if the electronic device 200 is following a path consistent with roadways and vehicular speeds. The combination of accelerometer and GPS data can offer a robust method for confirming that the device is in a vehicle. Furthermore, the system can utilize data from the vehicle's onboard diagnostics (OBD) system, if available, to corroborate the motion data. This can include information such as vehicle speed, engine status, and other operational parameters that indicate the vehicle is in use.

Each of these detection methods offers specific advantages. Accelerometers and gyroscopes provide immediate and continuous data on motion and orientation, enabling real-time detection of vehicular transport. GPS modules offer precise location tracking, which can be used to verify that the device is moving along a roadway. Integration with the vehicle's OBD system can provide additional confirmation and context, ensuring that the detection is accurate and reliable. By combining data from multiple sensors, the system can achieve a high level of confidence in determining that the electronic device 200 is being transported by the vehicle 116, thereby enabling appropriate adjustments to notification management and other functionalities.

Step 103 of FIG. 1 determines that a notification readout mode has been enabled, allowing the electronic device 200, when the communication device receives electronic communications, notifications, text messages, emails, and the like, to audibly present them such that they can be aurally received by the user 115. This determination ensures that the electronic device 200 is in a state where the electronic device 200 can effectively manage and present incoming communications in an audible format. By enabling the notification readout mode, the system can seamlessly transition from a standard notification delivery method to an audio-based presentation, which is particularly useful in scenarios where the user 115 cannot visually interact with the device, such as while driving.

Requiring this determination can be beneficial as the determination enhances user safety and convenience. When the notification readout mode is enabled, the electronic device 200 can automatically convert incoming text-based communications into audio readouts, allowing the user 115 to stay informed without diverting attention from tasks like driving. This reduces the cognitive load on the user and minimizes distractions, thereby promoting safer driving practices. Additionally, the audible presentation of notifications ensures that important messages are not missed, even when the user 115 is unable to look at the device, thus improving the overall user experience and communication efficiency.

In one or more embodiments, step 104 of FIG. 1 comprises the communication device of the electronic device 200 receiving a communication or electronic notification and filtering the same for aural presentation. This filtering process can involve several sub-steps to ensure that the notification is presented in a manner that is both efficient and user-friendly.

Illustrating by example, one sub-step includes creating a precis of the communication or notification. The precis serves as a concise summary, allowing the user to quickly grasp the information without being overwhelmed by the full content of the notification.

In one or more embodiments, step 104 comprises determining, by the one or more processors of the electronic device 200, an origination source of the notification. Advantageously, this allows the one or more processors at step 104 to compare origination source of the notification to a user defined list of prioritized origination sources stored in a memory of the electronic device. In one or more embodiments, the precis presented at step 107 is longer when the origination source is found in the user defined list of prioritized origination sources than when the origination source is absent from the user defined list of prioritized origination sources. Consequently, the precis of a text from mom would be longer than the precis of an email from a stranger for example.

Another sub-step involves determining a duration of presentation for the notification as shown at step 106. This step calculates the time required to aurally present the notification to the environment of the electronic device 200. By providing an estimate of the presentation duration, the system helps the user make an informed decision about whether to listen to the entire notification or not. This feature is particularly useful in managing the user's time and attention effectively.

The filtering process also includes determining an origination source of the notification. Identifying the source allows the system to prioritize notifications based on their importance or relevance to the user. For instance, notifications from a prioritized list of contacts or applications may be given precedence over others. Additionally, the system may determine a duration to aurally present the notification or communication to the environment of the electronic device 200. This ensures that the user receives the information in a timely and manageable format, reducing cognitive load and enhancing the overall user experience. Other processes that can be performed at step 104 will be obvious to those of ordinary skill in the art having the benefit of this disclosure.

Step 105 of FIG. 1 depicts the user 115 driving the vehicle 116 with the electronic device 200 safely mounted on the dash in a hands-free mode of operation. The electronic device 200, configured to operate in a hands-free mode, ensures that the user 115 can focus on driving without needing to physically interact with the device. This setup enhances safety by minimizing distractions and allowing the user 115 to keep their hands on the steering wheel and their eyes on the road.

As shown, a user interface 117 the electronic device 200 presents an indication that a notification or communication has been received. This indication presented on the user interface 117 can be an audible alert, a visual cue on the device's display, or a combination of both, designed to inform the user 115 of the incoming notification without requiring direct interaction. The indication presented on the user interface 117 serves as a prompt for the user 115, signaling that there is new information available that may require their attention.

The hands-free mode of operation, combined with the indication presented on the user interface 117, allows the user 115 to stay informed about important communications while maintaining safe driving practices. The electronic device 200 can then proceed to manage the notification by creating a precis of the content and presenting the precis audibly, ensuring that the user 115 receives the information in a concise and non-distracting manner. This approach optimizes the balance between staying connected and ensuring road safety.

In one or more embodiments, step 106 of FIG. 1 comprises one or more processors of the electronic device determining an amount of time required to audibly present the entire notification or communication. In one or more embodiments, this step 106 occurs before any audible presentation occurs, ensuring that the one or more processors have an estimate of the time needed to listen to the entire notification before any presentation occurs. The determination of this duration can be achieved through various methods, each offering specific benefits.

One method involves analyzing the length of the textual content of the notification. The processors can count the number of words or characters in the notification and use a predefined speech rate to calculate the total duration required for the audible presentation. This approach provides a straightforward and efficient way to estimate the duration, leveraging the known average speech rates to deliver a reliable estimate.

Another method employs natural language processing (NLP) techniques to analyze the complexity of the text. The processors can assess factors such as sentence structure, punctuation, and the presence of technical jargon or acronyms. By considering these elements, the system can adjust the estimated duration to account for variations in speech rate that may arise from more complex or technical content. This method enhances the accuracy of the duration estimate, ensuring that the user receives a realistic expectation of the time required to listen to the notification.

Additionally, the system can utilize machine learning algorithms trained on historical data to predict the duration of the audible presentation. By analyzing past notifications and their corresponding audible presentation times, the processors can develop a model that accurately estimates the duration for new notifications. This method benefits from continuous learning and improvement, as the model becomes more accurate over time with the accumulation of more data.

Each of these methods offers distinct advantages. The word or character count method provides a quick and efficient estimate, suitable for most general notifications. The NLP-based approach offers enhanced accuracy for more complex or technical content, ensuring that the user receives a precise duration estimate. The machine learning method leverages historical data to continuously improve the accuracy of the duration estimates, adapting to the user's specific notification patterns and preferences.

Step 107 involves creating, by the one or more processors of the electronic device 200 in response to the notification or communication being received, a precis of the notification or communication. The precis can be a summary of the notification or communication, which condenses the information into a more concise format. This step 107 ensures that the user receives a brief and relevant overview of the notification, reducing the cognitive load and minimizing distractions, especially in scenarios where the user cannot directly interact with the device, such as while driving.

Presenting, by the user interface 117 of the electronic device 200, the precis of the notification to an environment of the electronic device 200, which in this illustrative example is the interior of the vehicle 116, allows the user to quickly grasp the information without needing to engage with the device physically. The user interface 117 can deliver the precis audibly, ensuring that the user remains informed while maintaining focus on driving. This approach enhances safety by providing necessary information in a non-intrusive manner, allowing the user to stay connected without compromising attention on the road.

Optional step 108 allows the user 115 to deliver user input to the user interface 117 of the electronic device 200 to play the full notification or communication instead of the precis. This step 108 provides the user with the flexibility to override the default presentation of a concise summary and opt for the complete content of the notification. By enabling this user input, the system ensures that the user can access detailed information, when necessary, thereby enhancing the overall user experience and ensuring that information is not missed.

Optional step 109 allows the user 115 to select other communications or notifications. If the user selects another communication or notification, as determined by decision 110, the method 100 returns to step 106. This step 109 ensures that the system can handle multiple notifications efficiently, allowing the user to navigate through different messages and choose which ones to listen to in full. This functionality is particularly useful in scenarios where the user receives several notifications in quick succession and needs to prioritize which ones to address immediately.

If no other communication or notification is selected, the method proceeds to step 111. This step ensures that the system can conclude the notification management process smoothly, allowing the user to continue with their activities without unnecessary interruptions. By providing these optional steps, the system offers a flexible and user-centric approach to managing notifications, ensuring that the user can access important information while maintaining focus on their primary tasks.

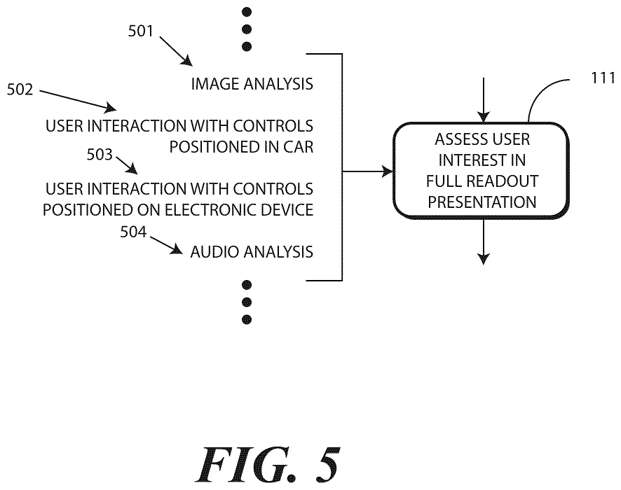

Step 111 of FIG. 1 detects, using one or more sensors of the electronic device, an interest level of the user 115 in the precis of the notification or communication being presented at step 107. Turning briefly to FIG. 5, illustrated therein are some explanatory examples. Others will be obvious to those of ordinary skill in the art having the benefit of this disclosure.

Illustrating by example, if the user 115 is engaged in a conversation while the precis of the communication or notification is being presented, as determined by audio analysis 504, step 111 determines that the user likely has a low interest level. Similarly, if the user is interacting 502 with the user controls of the vehicle 116, step 111 also determines that the user is unlikely to be interested in the precis. These determinations are based on the premise that engagement in other activities indicates a divided attention, reducing the likelihood of interest in the presented precis. Interaction 503 with the controls on the electronic device can show a low level of interest as well.

Several different techniques can be employed by the sensors of the electronic device 200 to detect user interest in the precis. One technique involves using microphones and audio analysis 504 to detect the presence or absence of speech. If the microphones detect that the user is speaking, the system infers a low interest level in the precis. Conversely, if the microphones detect silence, the system infers a higher interest level. This technique leverages audio analysis to gauge user engagement, providing a non-intrusive method to assess interest.

Another technique involves using image capture devices and image analysis 501 to monitor the user's interactions with the vehicle controls. If the image capture devices detect that the user is frequently adjusting the volume, changing the radio station, or interacting with other controls, the system infers a low interest level. This technique provides a visual assessment of user engagement, allowing the system to make informed decisions based on observed behavior.

Additionally, turning now back to FIG. 1, if the electronic device 200 were on the user's person, rather than on the dash as shown in FIG. 1, accelerometers and gyroscopes can be used to detect the user's physical movements. If the sensors detect that the user is making frequent or significant movements, such as turning their head or reaching for objects, the system infers a low interest level. This technique offers a motion-based assessment of user engagement, providing another layer of data to determine interest levels.

Each of these techniques offers specific advantages. Audio analysis using microphones provides real-time feedback on user engagement without requiring visual monitoring. Image capture devices offer a detailed visual assessment of user interactions, allowing for precise detection of engagement with vehicle controls. Motion-based assessments using accelerometers and gyroscopes provide a comprehensive view of the user's physical activity, offering insights into their level of distraction. By combining data from these various sensors, the system can achieve a high level of accuracy in determining the user's interest level in the precis, ensuring that notifications are managed effectively and safely.

Decision 112 of FIG. 1 determines whether the interest level of the user 115 exceeds a threshold. This determination can be achieved through various techniques, each leveraging different sensors and data points to assess user engagement. One technique involves using microphones to detect the presence or absence of speech. If the microphones detect that the user is silent, the system infers a higher interest level. Conversely, if the microphones detect that the user is engaged in a conversation, the system infers a lower interest level. This technique provides real-time feedback on user engagement without requiring visual monitoring.

Another technique involves using image capture devices to monitor the user's interactions with the vehicle controls. If the image capture devices detect that the user is frequently adjusting the volume, changing the radio station, or interacting with other controls, the system infers a lower interest level. This technique provides a visual assessment of user engagement, allowing the system to make informed decisions based on observed behavior. Additionally, accelerometers and gyroscopes can be used to detect the user's physical movements. If the sensors detect that the user is making frequent or significant movements, such as turning their head or reaching for objects, the system infers a lower interest level. This technique offers a motion-based assessment of user engagement, providing another layer of data to determine interest levels.

Several examples of thresholds can be employed to determine whether the interest level of the user 115 exceeds the threshold. For instance, a threshold can be set based on the duration of silence detected by the microphones. If the user remains silent for a predefined period, such as five seconds, the system infers a higher interest level. Another example involves setting a threshold based on the frequency of interactions with vehicle controls. If the user interacts with the controls less than a predefined number of times within a given period, the system infers a higher interest level. Similarly, a threshold can be set based on the magnitude and frequency of physical movements detected by accelerometers and gyroscopes. If the user's movements are minimal and infrequent, the system infers a higher interest level.

When the level of interest of the user 115 exceeds the threshold, the notification is presented in entirety at step 113. Otherwise, presentation of the notification or communication ceases at step 114. This ensures that the user receives the full content of the notification only when they are sufficiently engaged and able to process the information. By dynamically adjusting the presentation of notifications based on user engagement, the system minimizes distractions and enhances safety, particularly in scenarios where user attention is necessary, such as while driving. This adaptive approach to notification management provides a more intelligent and user-centric way of delivering information, improving the overall user experience.

Thus, as illustrated and described the method 100 of FIG. 1 comprises determining, by one or more sensors of the electronic device 200, that the electronic device 200 is being transported by a vehicle 116. The method 100 also determining, at step 106 in response to a communication device receiving a notification, a duration required to aurally present the notification to an environment of the electronic device 200 using a user interface 117.

At step 107, the method 100 generating, by one or more processors, a precis of the notification or communication. In one or more embodiments, step 107 occurs only while the electronic device 200 is moving in a vehicle 116.

In one or more embodiments, the precis comprises a summary of the notification or communication. Moreover, in one or more embodiments, the precis comprises an artificial intelligence (AI)-based summary of the notification. In one or more embodiments, the precis comprises a portion of the notification having a duration less than a predefined duration threshold that is less than the duration of time it would take to aurally deliver the communication or notification to the environment of the electronic device. In one or more embodiments, the precis comprises a first portion of the notification or communication.

At step 107, the method 100 optionally aurally presents, by the user interface 117, the duration required to aurally present the notification to the environment and the AI-based summary of the notification to the environment of the electronic device. Step 111 then assesses, using the one or more sensors, an interest by the user 115 of the electronic device 200 in the notification while the AI-based summary of the notification is being presented to the environment of the electronic device 200.

At step 113, when the one or more processors determine the authorized user is sufficiently interested in the notification at decision 112, the method 100 aurally presents, by the user interface 117, the notification in its entirety to the environment of the electronic device 200. As noted above, in one or more embodiments the aurally presenting the notification in its entirety to the environment of the electronic device 200 at step 113 occurs after the aurally presenting the AI-based summary of the notification to the environment of the electronic device 200 at step 107.

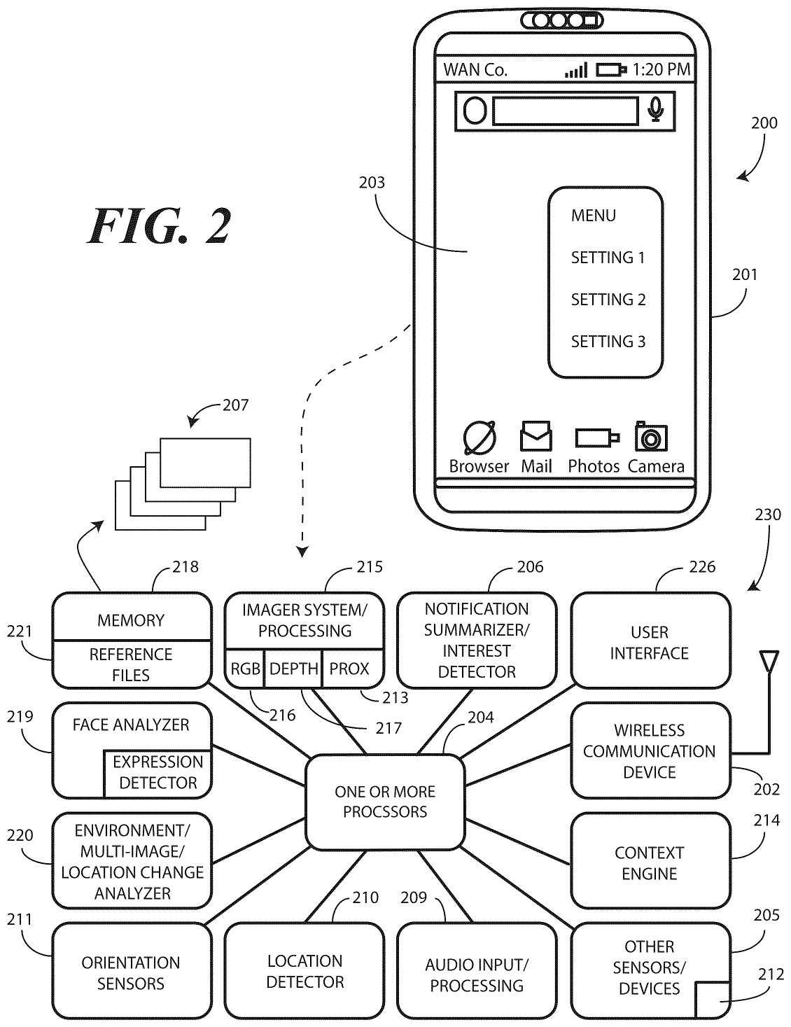

Turning now to FIG. 2, illustrated therein is one explanatory electronic device 200 configured in accordance with one or more embodiments of the disclosure. Also illustrated in FIG. 2 is one explanatory block diagram schematic 230 of one explanatory electronic device 200 configured in accordance with one or more embodiments of the disclosure.

It should be noted that the electronic device 200, while shown as a smartphone for illustrative purposes in FIG. 1 above, the electronic device 200 can be any of a number of various types of devices. For example, it should be obvious to those of ordinary skill in the art having the benefit of this disclosure that the block diagram schematic 230 could be used with other devices as well, including conventional desktop computers, palm-top computers, tablet computers, gaming devices, media players, wearable devices, or other devices. Still other devices will be obvious to those of ordinary skill in the art having the benefit of this disclosure.

In one or more embodiments, the block diagram schematic 230 is configured as a printed circuit board assembly disposed within a housing 201 of the electronic device 200. Various components can be electrically coupled together by conductors, or a bus disposed along one or more printed circuit boards.

The illustrative block diagram schematic 230 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 230 includes a user interface 226. In one or more embodiments, the user interface 226 includes a display 203, which may optionally be touch-sensitive. In one embodiment, users can deliver user input to the display 203 of such an embodiment by delivering touch input from a finger, stylus, or other objects disposed proximately with the display 203. In one embodiment, the display 203 is configured as an active matrix organic light emitting diode (AMOLED) display. However, it should be noted that other types of displays, including liquid crystal displays, suitable for use with the user interface 226 would be obvious to those of ordinary skill in the art having the benefit of this disclosure.

In one embodiment, the electronic device includes one or more processors 204. In one embodiment, the one or more processors 204 can include an application processor and, optionally, one or more auxiliary processors.

One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 230. Each of the application processor and the auxiliary processor(s) can be configured to process and execute executable software code to perform the various functions of the electronic device with which the block diagram schematic 230 operates. A storage device, such as memory 218, can optionally store the executable software code used by the one or more processors 204 during operation.

In this illustrative embodiment, the block diagram schematic 230 also includes a communication device 202 that can be configured for wired or wireless communication with one or more other devices or networks. The networks can include a wide area network, a local area network, and/or personal area network. The communication device 202 may also utilize wireless technology for communication, such as, but are not limited to, peer-to-peer or ad hoc communications such as HomeRF, Bluetooth, and IEEE 802.11, as well as other forms of wireless communication such as infrared technology. The communication device 202 can include wireless communication circuitry, one of a receiver, a transmitter, or transceiver, and one or more antennas.

In one embodiment, the one or more processors 204 can be responsible for performing the primary functions of the electronic device with which the block diagram schematic 230 is operational. For example, in one embodiment the one or more processors 204 comprise one or more circuits operable with the user interface 226 to present presentation information to a user. The executable software code used by the one or more processors 204 can be configured as one or more modules 207 that are operable with the one or more processors 204. Such modules 207 can store instructions, control algorithms, and so forth.

In one or more embodiments, the block diagram schematic 230 includes an audio input/processor 209. The audio input/processor 209 can include hardware, executable code, and speech monitor executable code in one embodiment. The audio input/processor 209 can include, stored in memory 218, basic speech models, trained speech models, or other modules that are used by the audio input/processor 209 to receive and identify voice commands that are received with audio input captured by an audio capture device. In one embodiment, the audio input/processor 209 can include a voice recognition engine. Regardless of the specific implementation utilized in the various embodiments, the audio input/processor 209 can access various speech models to identify speech commands.

In one embodiment, the audio input/processor 209 is configured to implement a voice control feature that allows a user to speak a specific device command to cause the one or more processors 204 to execute a control operation. For example, the audio input/processor 209 may deliver a device command requesting the one or more processors 204 to cooperate with the authentication system to authenticate a user. Consequently, this device command can cause the one or more processors 204 to access the authentication system and begin the authentication process.

The notification summarizer/interest detector 206 of FIG. 2 operates in conjunction with the communication device 202 and one or more sensors 205 to manage the presentation of notifications based on the attentiveness of an authorized user of the electronic device 200. Upon the communication device 202 receiving a notification, in one or more embodiments the notification summarizer/interest detector 206 determines the attentiveness of the authorized user by analyzing signals received from the sensors 205. These sensors may include image capture devices, microphones, accelerometers, and other motion-detecting components that provide real-time data on the user's engagement and activity levels.

When the sensors 205 indicate that the authorized user is inattentive, the notification summarizer/interest detector 206 causes the user interface 226 to present a precis of the notification. This precis can be in the form of a concise summary of the notification, designed to convey the information quickly and efficiently without requiring the user's full attention. The precis helps minimize distractions and cognitive load, particularly in scenarios where the user cannot directly interact with the device, such as while driving.

When the sensors 205 determine that the authorized user is attentive, the notification summarizer/interest detector 206 causes the user interface 226 to present the notification in entirety. This ensures that the user receives the full content of the notification when they are sufficiently engaged and able to process the information. By dynamically adjusting the presentation of notifications based on user attentiveness, the system optimizes the delivery of information, enhancing both safety and user experience. This adaptive approach leverages real-time data from the sensors to make intelligent decisions about how to present notifications, providing a more user-centric and efficient way of managing communications.

In one or more embodiments, the notification summarizer/interest detector 206 determines the attentiveness of the authorized user only when the electronic device is being transported by a vehicle. Where used, this feature ensures that the system prioritizes user safety by minimizing distractions while driving. By focusing on the user's attentiveness during vehicular transport, the system can dynamically adjust the presentation of notifications to reduce cognitive load and maintain the user's focus on the road. This approach can leverage real-time data from various sensors, such as accelerometers, gyroscopes, and GPS modules, to accurately detect when the electronic device is in a vehicle, thereby enabling appropriate adjustments to notification management and other functionalities.

In other embodiments, the notification summarizer/interest detector 206 can determine the attentiveness of the authorized user even when the electronic device 200 is not in a vehicle. This flexibility allows the system to adapt to different contexts and user environments, ensuring that notifications are managed effectively regardless of the user's location. For instance, the system can assess user attentiveness in scenarios such as walking, working, or engaging in other activities where direct interaction with the device may not be feasible. By extending the attentiveness detection capability beyond vehicular transport, the system provides a comprehensive solution for managing notifications in various situations, enhancing overall user experience and communication efficiency.

Various sensors 205 can be operable with the one or more processors 204. FIG. 2 illustrates several examples such sensors 205. It should be noted that those shown in FIG. 2 are not comprehensive, as others will be obvious to those of ordinary skill in the art having the benefit of this disclosure. Additionally, it should be noted that the various sensors 205 shown in FIG. 2 could be used alone or in combination. Accordingly, many electronic devices will employ only subsets of the sensors 205 shown in FIG. 2, with the particular subset defined by device application.

A first example of a sensor 205 that can be included with the other components is a touch sensor. The touch sensor can include a capacitive touch sensor, an infrared touch sensor, resistive touch sensors, or another touch-sensitive technology. Other types of touch sensors will be obvious to those of ordinary skill in the art having the benefit of this disclosure.

Another example of a sensor 205 is a geo-locator that serves as a location detector 210. In one embodiment, location detector 210 is able to determine location data when the electronic device 200 is moving in a vehicle, thereby informing the one or more processors 204 that the electronic device 200 is in a drive mode. This location data can be captured in a variety of ways, including by capturing the location data from a constellation of one or more earth orbiting satellites, or from a network of terrestrial base stations to determine an approximate location.

In one or more embodiments, the satellite positioning systems based location fixes of the location detector 210 autonomously or with assistance from terrestrial base stations, for example those associated with a cellular communication network or other ground based network, or as part of a Differential Global Positioning System (DGPS), as is well known by those having ordinary skill in the art. The location detector 210 may also be able to determine location by locating or triangulating terrestrial base stations of a traditional cellular network, or from other local area networks, such as Wi-Fi networks.

One or more motion detectors can be configured as orientation sensors 211 that determine an orientation and/or movement of the electronic device 200 in three-dimensional space. Illustrating by example, the orientation sensors 211 can include an accelerometer, gyroscopes, or other device to detect device orientation and/or motion of the electronic device 200. Using an accelerometer as an example, an accelerometer can be included to detect motion of the electronic device. Additionally, the accelerometer can be used to sense some of the gestures of the user, such as one talking with their hands, running, or walking.

The orientation sensors 211 can determine the spatial orientation of an electronic device 200 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 200.

The one or more sensors 205 can also include a gaze detector for detecting the user's gaze point. The gaze detector can optionally include sensors for detecting the alignment of a user's head in three-dimensional space. Electronic signals can then be processed for computing the direction of user's gaze in three-dimensional space. The gaze detector can further be configured to detect a gaze cone corresponding to the detected gaze direction, which is a field of view within which the user may easily see without diverting their eyes or head from the detected gaze direction. The gaze detector can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector of FIG. 2.

Other components 212 operable with the one or more processors 204 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 212 can also include proximity sensors 213. The proximity sensors 213 fall into one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 201 of the electronic device 200. In one embodiment, the signal receiver is an infrared signal receiver to receive an infrared emission from an object such as a human being when the human is proximately located with the electronic device 200.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 212 can optionally include a barometer or altimeter operable to sense changes in air pressure due to elevation changes or differing pressures of the electronic device 200. The other components 212 can also optionally include a light sensor that detects changes in optical intensity, color, light, or shadow in the environment of an electronic device. An infrared sensor can be used in conjunction with, or in place of, the light sensor. Similarly, the other components 212 can include a temperature sensor configured to monitor temperature about an electronic device 200.

A context engine 214 can then be operable with the various sensors to detect, infer, capture, and otherwise determine persons and actions that are occurring in an environment about the electronic device 200, including whether an authorized user of the electronic device 200 has interest in a precis of a notification being presented aurally by the user interface 226. For example, where included one embodiment of the context engine 214 determines assessed contexts and frameworks using adjustable algorithms of context assessment employing information, data, and events.

These assessments may be learned through repetitive data analysis. These assessments can be used to assess an interest of the authorized user of the electronic device 200 in a notification, for example, while an AI-based summary of the notification is being presented to an environment of the electronic device 200. Alternatively, a user may employ the user interface 226 to enter various parameters, constructs, rules, and/or paradigms that instruct or otherwise guide the context engine 214 in determining this interest. The context engine 214 can make such determinations by detecting multi-modal social cues, emotional states, moods, and other contextual information. The context engine 214 can comprise an artificial neural network or other similar technology in one or more embodiments.

In one or more embodiments, the context engine 214 and notification summarizer/interest detector 206 are operable with the one or more processors 204. In some embodiments, the one or more processors 204 can control the context engine 214 and notification summarizer/interest detector 206. In other embodiments, the context engine 214 and notification summarizer/interest detector 206 can operate independently, delivering information gleaned from detecting multi-modal social cues, emotional states, moods, and other contextual information to the one or more processors 204. The context engine 214 and notification summarizer/interest detector 206 can receive data from the various sensors. In one or more embodiments, the one or more processors 204 are configured to perform the operations of the context engine 214 and the notification summarizer/interest detector 206.

In one or more embodiments, the imager processor system 215 comprises an imager 216 that can be operable with the authentication system. The imager processors system 215 can also include an optional depth imager 217, which can also be operable with the authentication system.

In one embodiment, the imager 216 comprises a two-dimensional imager configured to receive at least one image of a person within an environment of the electronic device 200. Illustrating by example, in one or more embodiments the imager 216 is configured as an image capture device operable to capture one or more images of an authorized user of the electronic device 200 while a precis of a notification is being presented to an environment of the electronic device 200. In one or more embodiments, the one or more processors 204 determine the attentiveness of the user to be inattentive when image analysis performed by the imager processors system 215 on one or more images of the authorized user depict the authorized user interacting with one or more user controls of the vehicle.

In one embodiment, the imager 216 comprises a two-dimensional RGB imager. In another embodiment, the imager 216 comprises an infrared imager. Other types of imagers suitable for use as the imager 216 of the authentication system will be obvious to those of ordinary skill in the art having the benefit of this disclosure.

The depth imager 217, where included, can take a variety of forms. For example, the depth imager 217 can comprise a pair of imagers separated by a predetermined distance, such as three to four images. This “stereo” imager works in the same way the human eyes do in that it captures images from two different angles and reconciles the two to determine distance.

Alternatively, the depth imager 217 can comprise a structured light laser that projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 217 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, where included the depth imager 217 adds detection of a third “z-dimension” to the x-dimension and y-dimension captured by the imager 216. This additional dimension can be used to enhance the security of using a person's face as authentication data, be it for use as their password in the process of authentication by facial recognition or for use as additional authorization to transmit media content when the one or more processors 204 prompt the person for the same.

In one or more embodiments, the authentication system can be operable with a face analyzer 219 and/or an environmental analyzer 220. The face analyzer 219 and/or environmental analyzer 220 can be configured to process an image or depth scan of an object and determine whether the object matches predetermined criteria, including whether an interest level of an authorized user exceeds a threshold.

For example, the face analyzer 219 and/or environmental analyzer 220 can operate as an identification module configured with optical and/or spatial recognition to identify objects using image recognition, character recognition, visual recognition, facial recognition, color recognition, shape recognition, and the like. Advantageously, the face analyzer 219 and/or environmental analyzer 220, operating in tandem with the authentication system, can be used as a facial recognition device to determine the identity of one or more persons detected about the electronic device 200.

In one or more embodiments, when the authentication system detects a person, one or both of the imager 216 and/or the depth imager 217 can capture a photograph and/or depth scan of that person. The authentication system can then compare the image and/or depth scan to one or more predefined authentication reference files 221 stored in the memory 218. This comparison, in one or more embodiments, is used to confirm beyond a threshold authenticity probability that the person's face—both in the image and the depth scan—sufficiently matches one or more of the reference files 221.

Beneficially, this optical recognition performed by the authentication system operating in conjunction with the face analyzer 219 and/or environmental analyzer 220 allows the one or more processors 204 to detect an interest level of an authorized user in a precis of a notification being presented by the user interface 226.

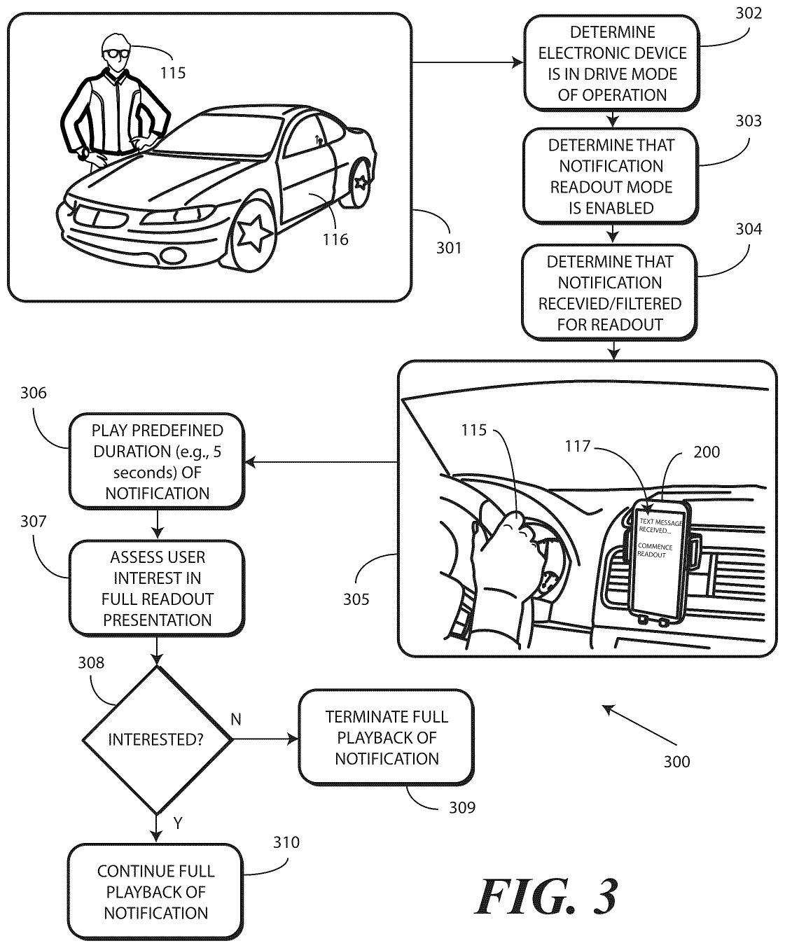

Turning now to FIG. 3, illustrated therein is one explanatory method 300 for using the electronic device (200) of FIG. 2. In contrast to the method (100) of FIG. 1, in the method 300 of FIG. 3, the precis of the notification comprises a first portion of the notification have a duration less than a predefined threshold, shown illustratively as being five seconds or so at step 306.

Beginning at step 301, a user 115, with an electronic device 200 in her pocket, approaches her vehicle 116, again ready to embark on a trip to Buster's Chicken Shack. At step 302 of FIG. 3, one or more sensors of the electronic device 200 determine that the electronic device 200 is being transported by the vehicle 116.

Step 303 of FIG. 3 determines that a notification readout mode has been enabled, allowing the electronic device 200, when the communication device receives electronic communications, notifications, text messages, emails, and the like, to audibly present them such that they can be aurally received by the user 115. This determination ensures that the electronic device 200 is in a state where the electronic device 200 can effectively manage and present incoming communications in an audible format. By enabling the notification readout mode, the system can seamlessly transition from a standard notification delivery method to an audio-based presentation, which is particularly useful in scenarios where the user 115 cannot visually interact with the device, such as while driving.

In one or more embodiments, step 304 of FIG. 3 comprises the communication device of the electronic device 200 receiving a communication or electronic notification and filtering the same for aural presentation. As before, this filtering process can involve several sub-steps to ensure that the notification is presented in a manner that is both efficient and user-friendly.

In the illustrative embodiment of FIG. 3, one sub-step includes creating a precis of the communication or notification by truncating the notification such that the precis comprises a first portion of the notification having a duration less than a predefined threshold, such as three, five, ten, fifteen, or twenty seconds. The precis serves as a an introduction to the notification's content, allowing the user to quickly grasp the information without being overwhelmed by the full content of the notification.

Step 305 of FIG. 3 depicts the user 115 driving the vehicle 116 with the electronic device 200 safely mounted on the dash in a hands-free mode of operation. The electronic device 200, configured to operate in a hands-free mode, ensures that the user 115 can focus on driving without needing to physically interact with the device.

In one or more embodiments, step 306 of FIG. 3 comprises presenting, by the user interface 117 of the electronic device 200, the precis of the notification to an environment of the electronic device 200, which in this illustrative example is the interior of the vehicle 116. Advantageously, this allows the user to quickly grasp the information without needing to engage with the device physically. The user interface 117 can deliver the precis audibly, ensuring that the user remains informed while maintaining focus on driving. This approach enhances safety by providing necessary information in a non-intrusive manner, allowing the user to stay connected without compromising attention on the road.

Decision 308 of FIG. 3 detects, using one or more sensors of the electronic device, an interest level of the user 115 in the precis of the notification or communication being presented at step 307. Illustrating by example, if the user 115 is engaged in a conversation while the precis of the communication or notification is being presented, the system determines that the user likely has a low interest level. Similarly, if the user is interacting with the user controls of the vehicle 116, the system also determines that the user is unlikely to be interested in the precis. These determinations are based on the premise that engagement in other activities indicates a divided attention, reducing the likelihood of interest in the presented precis.

Decision 308 of FIG. 3 determines whether the interest level of the user 115 exceeds a threshold. This determination can be achieved through various techniques, each leveraging different sensors and data points to assess user engagement. One technique involves using microphones to detect the presence or absence of speech. If the microphones detect that the user is silent, the system infers a higher interest level. Conversely, if the microphones detect that the user is engaged in a conversation, the system infers a lower interest level. This technique provides real-time feedback on user engagement without requiring visual monitoring. Other techniques for determining this level of interest were described above with reference to FIG. 1 and can apply here as well.

When the level of interest of the user 115 exceeds the threshold, the notification is presented in entirety at step 310. Otherwise, presentation of the notification or communication ceases at step 309. This ensures that the user receives the full content of the notification only when they are sufficiently engaged and able to process the information. By dynamically adjusting the presentation of notifications based on user engagement, the system minimizes distractions and enhances safety, particularly in scenarios where user attention is necessary, such as while driving. This adaptive approach to notification management provides a more intelligent and user-centric way of delivering information, improving the overall user experience.

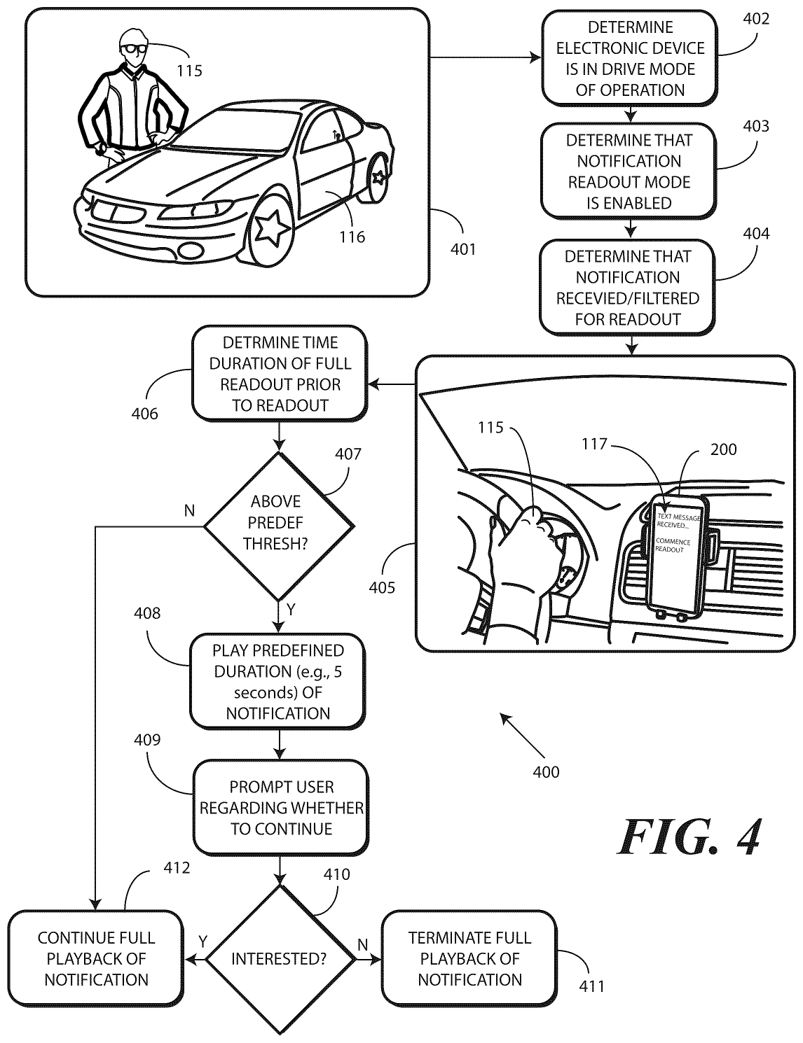

Turning now to FIG. 4, illustrated therein is another explanatory method 400 for using the electronic device (200) of FIG. 2. In the method 400 of FIG. 4, there is an additional step 409 that provides, on the user interface 117 after the presenting the precis of the notification to the environment of the electronic device 200, a prompt requesting user input confirming the authorized user of the electronic device 200 desires to hear the notification in its entirety. As determined at decision 410, the presenting the notification in its entirety to the environment of the electronic device 200 at step 412 only occurs when user input confirming the authorized user of the electronic device 200 desires to hear the notification in its entirety is received by the user interface 117 in response to provision of the prompt.

Beginning at step 401, a user 115, with an electronic device 200 in her pocket, approaches her vehicle 116, again ready to embark on a trip to Buster's Chicken Shack. At step 402 of FIG. 4, one or more sensors of the electronic device 200 determine that the electronic device 200 is being transported by the vehicle 116.

Step 403 determines that a notification readout mode has been enabled, allowing the electronic device 200, when the communication device receives electronic communications, notifications, text messages, emails, and the like, to audibly present them such that they can be aurally received by the user 115. By enabling the notification readout mode, the system can seamlessly transition from a standard notification delivery method to an audio-based presentation, which is particularly useful in scenarios where the user 115 cannot visually interact with the device, such as while driving.

Step 404 comprises the communication device of the electronic device 200 receiving a communication or electronic notification and filtering the same for aural presentation. As before, this filtering process can involve several sub-steps to ensure that the notification is presented in a manner that is both efficient and user-friendly.

Step 405 then depicts the user 115 driving the vehicle 116 with the electronic device 200 safely mounted on the dash in a hands-free mode of operation. The electronic device 200, configured to operate in a hands-free mode, ensures that the user 115 can focus on driving without needing to physically interact with the device.

In one or more embodiments, step 406 comprises determining, by the one or more processors, a duration of presentation for the notification. Optionally, step 406 can further comprise announcing, by the user interface 117 in conjunction with the presenting the precis of the notification to the environment of the electronic device 200, the duration of presentation.

In one or more embodiments, step 406 can comprise determining, by the one or more sensors while the electronic device 200 is moving in the vehicle 116, a duration of travel expected for the vehicle 116. Advantageously, when decision 407 determines that the duration of travel is longer than the time required to aurally present the notification, step 408 can comprise delivering the precis to the environment of the electronic device 200. By contrast, when the duration required to aurally present the notification is less than the duration of travel, step 412 can present the entire notification. It should be noted that in one or more embodiments, the presenting the precis at step 412, and also the presenting the notification in its entirety at step 412, comprise presenting aural representations of the precis and the notification in its entirety, respectively.

Where the precis is presented at step 408, step 409 comprises providing, on the user interface 117 after the presenting the precis of the notification to the environment of the electronic device 200, a prompt requesting user input confirming the authorized user of the electronic device 200 desires to hear the notification in its entirety. In one or more embodiments, the prompt further presents, by the user interface 117 to the environment of the electronic device 200, at least one remainder duration of presentation for the notification. In other embodiments, this remainder duration of presentation for the notification can be presented while also presenting the notification in its entirety to the environment of the electronic device 200, such as at step 412.

Decision 410 can then determine whether user input is received by the user interface 117 after presentation the prompt. Where it is, step 412 can comprise also presenting the notification in its entirety to the environment of the electronic device 200. In one or more embodiments, this only occurs when user input confirming the authorized user of the electronic device 200 desires to hear the notification in its entirety is received by the user interface 117 in response to provision of the prompt. Otherwise, presentation of the notification or communication ceases at step 411.

This ensures that the user receives the full content of the notification only when they are sufficiently engaged and able to process the information. By dynamically adjusting the presentation of notifications based on user engagement, the system minimizes distractions and enhances safety, particularly in scenarios where user attention is necessary, such as while driving. This adaptive approach to notification management provides a more intelligent and user-centric way of delivering information, improving the overall user experience.

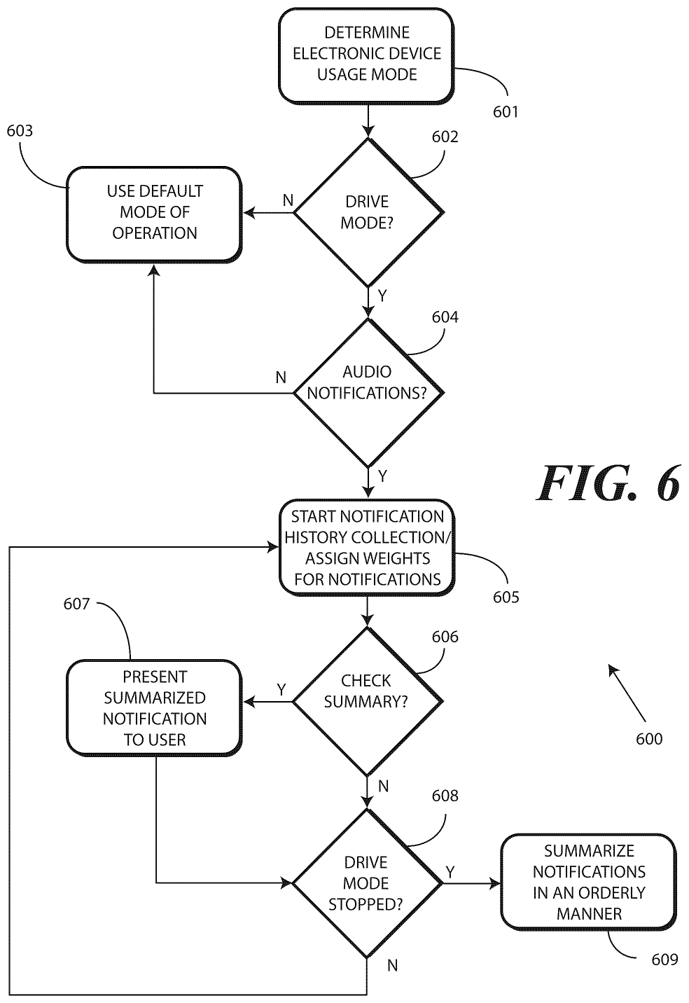

Turning now to FIG. 6, illustrated therein is still another explanatory method 600 in accordance with one or more embodiments of the disclosure.

Step 601 initiates the method 600 by determining, using one or more sensors, a mode of operation of an electronic device. Where decision 602 determines that the electronic device is in a drive mode, decision 604 checks whether audio notifications have been enabled. In one or more embodiments, when the electronic device is not experiencing a drive mode, or where audio notifications have not been enabled, a default mode of operation is used at step 603.

Step 605 starts a notification collection, and optionally assigns weights to prioritize notifications. In one or more embodiments, step 605 of FIG. 6 initiates a notification history collection process that captures notifications received by a communication device. This step 605 can involve storing each notification in a database, allowing the system to maintain a comprehensive record of all incoming communications.

The storage process can utilize various techniques, such as timestamping each notification to preserve the order of receipt, categorizing notifications based on their type (e.g., SMS, email, app alerts), and indexing them for quick retrieval. By maintaining a detailed history of notifications, the system ensures that users can access past communications efficiently, enhancing the overall user experience.

In addition to storing notifications, step 605 optionally assigns weights to these notifications to prioritize them according to user preferences. This weighting process can employ several techniques, each offering distinct benefits. One approach involves user-defined rules, where users specify criteria for prioritizing notifications, such as sender importance, message content, or urgency. For example, notifications from family members or work-related emails can be assigned higher weights, ensuring they appear at the top of the notification list. This method allows users to tailor the notification system to their specific needs, providing a personalized experience.

Another technique for assigning weights leverages machine learning algorithms to analyze user behavior and preferences. The system can learn from past interactions, identifying patterns in how users respond to different types of notifications. By continuously updating the weighting criteria based on user actions, the system can dynamically adjust the priority of incoming notifications, ensuring that the most relevant and important messages are highlighted. This adaptive approach enhances the system's ability to meet user expectations and preferences over time.

Additionally, the method 600 can incorporate contextual information to refine the weighting process. For instance, the system can consider the user's current activity, location, or time of day when assigning weights to notifications. Notifications received during work hours might be prioritized differently than those received during leisure time, ensuring that the user is not overwhelmed with less significant information when focus is required. This context-aware weighting mechanism provides a more intelligent and responsive notification management system, improving the overall efficiency and relevance of the notifications presented to the user.

Decision 606 of FIG. 6 determines whether a user wishes to have summaries of notifications presented in real time. This determination can be achieved through various techniques, each offering distinct benefits. One technique involves user preferences stored in the electronic device. The user can preconfigure settings indicating a preference for real-time summaries. This method allows the system to automatically present summaries based on the user's predefined choices, ensuring a seamless and personalized experience.

Another technique employs machine learning algorithms to analyze user behavior and preferences over time. The system can learn from past interactions, identifying patterns in how users respond to different types of notifications. By continuously updating the criteria based on user actions, the system can dynamically adjust the presentation of summaries, ensuring that the most relevant and important messages are highlighted. This adaptive approach enhances the system's ability to meet user expectations and preferences over time.

Additionally, the system can utilize contextual information to refine the decision-making process. For instance, the system can consider the user's current activity, location, or time of day when determining whether to present real-time summaries. Notifications received during work hours might be summarized differently than those received during leisure time, ensuring that the user is not overwhelmed with less significant information when focus is required. This context-aware mechanism provides a more intelligent and responsive notification management system, improving the overall efficiency and relevance of the notifications presented to the user.

Where decision 606 is made in the affirmative, step 607 comprises aurally presenting, by the user interface, the duration required to aurally present the notification to the environment and the AI-based summary of the notification to the environment of the electronic device. Otherwise, decision 608 determines when the drive mode ceases. Thereafter, notifications are presented in an orderly manner at step 609.

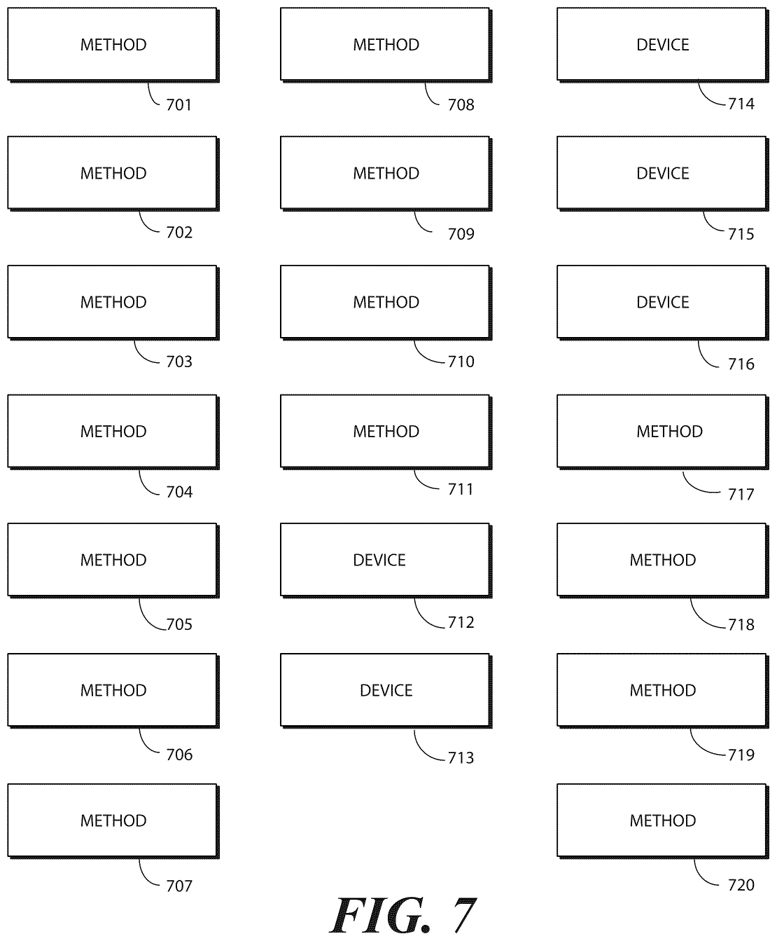

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises creating, by one or more processors in response to a notification being received by a communication device of the electronic device, a precis of the notification. At 701, the method comprises presenting, by a user interface of the electronic device, the precis of the notification to an environment of the electronic device.

At 701, the method comprises detecting, by one or more sensors in response to the presenting, an interest level of an authorized user of the electronic device in the precis of the notification. At 701, where the interest level of the authorized user of the electronic device exceeds a threshold, the method comprises also presenting the notification in its entirety to the environment of the electronic device.

At 702, the method of 701 further comprises determining, by the one or more processors, a duration of presentation for the notification. At 702, the method comprises announcing, by the user interface in conjunction with the presenting the precis of the notification to the environment of the electronic device, the duration of presentation.

At 703, the creating of 702 occurs only while the electronic device is moving in a vehicle. At 704, the precis of 703 comprises a summary of the notification. At 705, the precis of 704 is created using artificial intelligence (AI) processing.

At 706, the precis of 703 comprises a portion of the notification having a duration less than a predefined threshold. At 707, the portion of 706 comprises a first portion of the notification.

At 708, the method of 703 further comprises providing, on the user interface after the presenting the precis of the notification to the environment of the electronic device, a prompt requesting user input confirming the authorized user of the electronic device desires to hear the notification in its entirety. At 708, the also presenting the notification in its entirety to the environment of the electronic device only occurs when user input confirming the authorized user of the electronic device desires to hear the notification in its entirety is received by the user interface in response to provision of the prompt.

At 709, the method of 703 further comprises determining, by the one or more sensors while the electronic device is moving in the vehicle, a duration of travel expected for the vehicle. At 708, a duration of presentation of the precis is less than the duration of travel expected for the vehicle.

At 710, the detecting of 703 the interest level of the authorized user of the electronic device in the precis of the notification comprises determining, using the one or more sensors, whether the authorized user of the electronic device is engaged in a conversation. At 711, the detecting of 703 the interest level of the authorized user of the electronic device in the precis of the notification comprises determining, from signals received from the vehicle, whether the authorized user of the electronic device is interacting with one or more user controls of the vehicle.

At 712, the method of 703 further comprises determining, by the one or more processors, an origination source of the notification. At 712, the method comprises comparing, by the one or more processors, the origination source of the notification to a user defined list of prioritized origination sources. At 712, the precis is longer when the origination source is found in the user defined list of prioritized origination sources than when the origination source is absent from the user defined list of prioritized origination sources.

At 713, the method pf 703 further comprises presenting, by the user interface to the environment of the electronic device, at least one remainder duration of presentation for the notification while also presenting the notification in its entirety to the environment of the electronic device. At 714, the presenting of 703 of the precis and the also presenting the notification in its entirety comprise presenting aural representations of the precis and the notification in its entirety, respectively.

At 715, an electronic device comprises a user interface, one or more sensors, a communication device, and one or more processors operable with the user interface, the one or more sensors, and the communication device. At 715, the one or more processors, in response to the communication device receiving a notification, determine, from signals received by the one or more sensors, an attentiveness of an authorized user of the electronic device and cause the user interface to present a precis of the notification when the attentiveness of the authorized user is determined to be inattentive, and present the notification in its entirety when the attentiveness of the authorized user is determined to be attentive.

At 716, the one or more processors of 715 determine the attentiveness of the authorized user only when the electronic device is being transported by a vehicle. At 717, the one or more sensors of 716 comprise an image capture device. At 717, the one or more processors determine the attentiveness of the user to be inattentive when image analysis performed on one or more images of the authorized user depict the authorized user interacting with one or more user controls of the vehicle.

At 718, the one or more sensors of 715 comprise one or more microphones. At 718, the one or more processors determine the attentiveness of the authorized user to be attentive when the one or more microphones detect an absence of speech from the authorized user of the electronic device.

At 719, a method in an electronic device comprises determining, by one or more sensors of the electronic device, that the electronic device is being transported by a vehicle. At 719, the method comprises determining, in response to a communication device receiving a notification, a duration required to aurally present the notification to an environment of the electronic device using a user interface.

At 719, the method comprises generating, by one or more processors, an artificial intelligence (AI)-based summary of the notification. At 719, the method comprises aurally presenting, by the user interface, the duration required to aurally present the notification to the environment and the AI-based summary of the notification to the environment of the electronic device

At 719, the method comprises assessing, using the one or more sensors, an interest by an authorized user of the electronic device in the notification while the AI-based summary of the notification is being presented to the environment of the electronic device. At 719, the method comprises, where the one or more processors determine the authorized user is sufficiently interested in the notification, aurally presenting, by the user interface, the notification in its entirety to the environment of the electronic device. At 720, the aurally presenting the notification in its entirety to the environment of the electronic device of 719 occurs after the aurally presenting the AI-based summary of the notification to the environment of the electronic device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
creating, by one or more processors in response to a notification being received by a communication device of the electronic device, a precis of the notification;
presenting, by a user interface of the electronic device, the precis of the notification to an environment of the electronic device;
detecting, by one or more sensors in response to the presenting, an interest level of an authorized user of the electronic device in the precis of the notification; and
where the interest level of the authorized user of the electronic device exceeds a threshold, also presenting the notification in its entirety to the environment of the electronic device.

2. The method of claim 1, further comprising:
determining, by the one or more processors, a duration of presentation for the notification; and
announcing, by the user interface in conjunction with the presenting the precis of the notification to the environment of the electronic device, the duration of presentation.

3. The method of claim 2, wherein the creating occurs only while the electronic device is moving in a vehicle.

4. The method of claim 3, wherein the precis comprises a summary of the notification.

5. The method of claim 4, wherein the precis is created using artificial intelligence (AI) processing.

6. The method of claim 3, wherein the precis comprises a portion of the notification having a duration less than a predefined threshold.

7. The method of claim 6, wherein the portion comprises a first portion of the notification.

8. The method of claim 3, further comprising providing, on the user interface after the presenting the precis of the notification to the environment of the electronic device, a prompt requesting user input confirming the authorized user of the electronic device desires to hear the notification in its entirety, wherein the also presenting the notification in its entirety to the environment of the electronic device only occurs when user input confirming the authorized user of the electronic device desires to hear the notification in its entirety is received by the user interface in response to provision of the prompt.

9. The method of claim 3, further comprising determining, by the one or more sensors while the electronic device is moving in the vehicle, a duration of travel expected for the vehicle, wherein a duration of presentation of the precis is less than the duration of travel expected for the vehicle.

10. The method of claim 3, wherein the detecting the interest level of the authorized user of the electronic device in the precis of the notification comprises determining, using the one or more sensors, whether the authorized user of the electronic device is engaged in a conversation.

11. The method of claim 3, wherein the detecting the interest level of the authorized user of the electronic device in the precis of the notification comprises determining, from signals received from the vehicle, whether the authorized user of the electronic device is interacting with one or more user controls of the vehicle.

12. The method of claim 3, further comprising:
determining, by the one or more processors, an origination source of the notification; and
comparing, by the one or more processors, the origination source of the notification to a user defined list of prioritized origination sources;
wherein the precis is longer when the origination source is found in the user defined list of prioritized origination sources than when the origination source is absent from the user defined list of prioritized origination sources.

13. The method of claim 3, further comprising presenting, by the user interface to the environment of the electronic device, at least one remainder duration of presentation for the notification while also presenting the notification in its entirety to the environment of the electronic device.

14. The method of claim 3, wherein the presenting the precis and the also presenting the notification in its entirety comprise presenting aural representations of the precis and the notification in its entirety, respectively.

15. An electronic device, comprising:
a user interface;
one or more sensors;
a communication device; and
one or more processors operable with the user interface, the one or more sensors, and the communication device;
wherein the one or more processors, in response to the communication device receiving a notification, determine, from signals received by the one or more sensors, an attentiveness of an authorized user of the electronic device and cause the user interface to present a precis of the notification when the attentiveness of the authorized user is determined to be inattentive, and present the notification in its entirety when the attentiveness of the authorized user is determined to be attentive.

16. The electronic device of claim 15, wherein the one or more processors determine the attentiveness of the authorized user only when the electronic device is being transported by a vehicle.

17. The electronic device of claim 16, wherein:
the one or more sensors comprise an image capture device; and
the one or more processors determine the attentiveness of the user to be inattentive when image analysis performed on one or more images of the authorized user depict the authorized user interacting with one or more user controls of the vehicle.

18. The electronic device of claim 15, wherein:
the one or more sensors comprise one or more microphones; and
the one or more processors determine the attentiveness of the authorized user to be attentive when the one or more microphones detect an absence of speech from the authorized user of the electronic device.

19. A method in an electronic device, comprising:
determining, by one or more sensors of the electronic device, that the electronic device is being transported by a vehicle;
determining, in response to a communication device receiving a notification, a duration required to aurally present the notification to an environment of the electronic device using a user interface;
generating, by one or more processors, an artificial intelligence (AI)-based summary of the notification;
aurally presenting, by the user interface, the duration required to aurally present the notification to the environment and the AI-based summary of the notification to the environment of the electronic device;
assessing, using the one or more sensors, an interest by an authorized user of the electronic device in the notification while the AI-based summary of the notification is being presented to the environment of the electronic device; and
where the one or more processors determine the authorized user is sufficiently interested in the notification, aurally presenting, by the user interface, the notification in its entirety to the environment of the electronic device.

20. The method of claim 19, wherein the aurally presenting the notification in its entirety to the environment of the electronic device occurs after the aurally presenting the AI-based summary of the notification to the environment of the electronic device.
